(19) United States
(12) Patent Application Publication
(10) Pub. No.: US 2015/0310949 A1
(43) Pub. Date: Oct. 29, 2015

(54) WATER INTAKE INSTALLATION FOR COOLING A NUCLEAR POWER PLANT, AND NUCLEAR POWER PLANT COMPRISING SUCH AN INSTALLATION

(71) Applicant: ELECTRICITE DE FRANCE, Paris (FR)

(72) Inventor: Christophe Legendre, Virandeville (FR)

(73) Assignee: ELECTRICTIE DE FRANCE, Paris (FR)

(21) Appl. No.: 14/653,474

(22) PCT Filed: Dec. 19, 2013
(86) PCT No.: PCT/FR2013/053199

§ 371 Date: Jun. 18, 2015

(30) Foreign Application Priority Data
Dec. 20, 2012 (FR) 12 62410

(51) Int. Cl. G21D 3/04; E21D 9/14; G21D 1/00

(52) U.S. Cl. CPC G21D 3/04; G21D 1/00; E21D 9/14

(57) ABSTRACT

Water intake installation to supply water to a heat exchanger cooling circuit of one or more reactor units of a nuclear power plant, and comprising a suction basin from which a pumping station sucks water. The installation further comprises a suction tunnel communicating with the suction basin to supply it with water, connected to two water intakes submerged in a body of water. A part of the suction tunnel forms a loop having two ends that communicate with the suction basin. The disclosure also relates to a method for producing such a water intake installation, as well as a nuclear power plant comprising such an installation, optionally with several reactor units supplied with water by a same suction basin.

The invention relates to a water intake installation for at least one heat exchanger-based cooling circuit of one or more reactor units of a nuclear power plant, comprising a suction basin supplied with water and from which at least one pumping station of the plant draws water in order to circulate it within said cooling circuit, and further comprising a suction tunnel communicating with the suction basin to supply it with water, connected to at least two water intakes submerged in a body of water such as a sea, lake, or river.

The heat exchanger-based cooling circuit is typically designed to cool the steam exiting a turbine-generator in a secondary circuit of a reactor of the nuclear plant, in order to condense this steam so that water returned to the liquid state is fed back to the steam generators of the secondary circuit. The steam generators draw heat from a pressurized primary circuit to cool the reactor, by heat exchange between the primary circuit and the secondary circuit. The primary and secondary circuits are closed systems fluid-wise, while the heat exchanger-based cooling circuit is open and completely isolated from the secondary circuit which in turn is completely isolated from the primary circuit. The water exiting a heat exchanger is therefore not radioactive, and can be drained away for example to be returned to the body of water supplying the circuit.

A water intake installation as defined above is known, particularly the Seabrook nuclear power plant, constructed near the shore in southern New Hampshire (USA) and commissioned in 1990. The installation comprises a single mostly straight suction tunnel several kilometers long, having an end portion located under the seabed and connected to three regularly distributed vertical suction shafts spaced less than thirty meters apart. Each suction shaft opens just above the seabed and comprises an upper portion forming one of said submerged water intakes, located about fifteen meters below the water level. Each water intake is fitted with grilles sized to prevent large marine animals such as seals from entering the suction tunnel and becoming lost inside.

This known installation does not fully meets the single-failure criterion, which specifies that a safety system must be capable of performing its functions even if a single failure affects one of its components. This criterion generally requires redundancy in essential safety functions. The installation meets this criterion in the event of failure of one or even two of the three suction shafts, for example in case of damage to a water intake of a shaft by a boat sinking directly onto the water intake, but it does not provide redundancy of the suction tunnel such that the normal supply of water to the suction basin continues when there is significant damage in the tunnel. Significant damage could occur, for example, in the event of the admittedly unlikely scenario of a collapse in a section of the tunnel.

Also known, from Japanese patent application no. JP60111089A published on 17 Jun. 1985, is a water intake installation comprising a suction basin supplied with water by an underground suction tunnel, the tunnel being connected to a water intake submerged at a relatively shallow depth in the sea, such that the water intake could be left exposed before a tsunami wave. This document does not provide for duplication of the water intake and/or suction tunnel. Note that in the case of a plant near the shoreline in an area at significant risk of tsunami or tidal wave, often the suction basin is fed with water through an underground suction tunnel passing below a dike that protects the plant.

To satisfy the single-failure criterion in the example case of at least partial obstruction of a tunnel after a collapse within the tunnel, it is possible to provide a design of two identical suction tunnels arranged in parallel. This solution involves significant construction costs, however.

The present invention aims to provide a water intake installation meeting the single-failure criterion at a construction cost that is significantly less than the cost of the above solution.

To this end, the invention relates to a water intake installation as defined in the preamble above, characterized in that at least a portion of said suction tunnel forms a loop having two ends which communicate with the suction basin.

With these arrangements, it is possible to satisfy the single-failure criterion without requiring two independent suction tunnels. A significant advantage of such a construction is that the suction tunnel can be dug by a tunnel boring machine (TBM) along a single path, if the construction technique used allows creating the tunnel with a certain curvature. By choosing a tunnel location in a geological area where the subsoil is not too hard, excavating the tunnel along a single path generally allows the TBM to use a single cutter head.

In comparison, the excavation of two independent suction tunnels which each end beneath the sea raises the issue of retrieving the TBM that dug each tunnel, and in all cases the cutter head has to be abandoned in the tunnel under the seabed, which requires using at least two cutter heads to dig the two suction tunnels. The applicant has carried out comparative studies of tunnel construction costs for the same arrangement of two water intakes distanced from one another, and believes that the solution of the invention generally provides significantly lower construction costs, despite the total length of the looped tunnel being longer than the total length of two parallel and independent suction tunnels. In addition, the inspection and maintenance operations by robots or divers are estimated to be faster and less expensive for a looped tunnel than for two independent suction tunnels. As an example, one robot can inspect the looped tunnel in a single operation, as the robot can be introduced at one end of the tunnel, traverse the entire tunnel, and exit the other end.

In addition, as detailed below, in the case of local obstruction caused for example by a collapse in the tunnel, two water intakes connected to the looped suction tunnel are sufficient for the suction basin to remain generally supplied with water by the two water intakes. This configuration is advantageous in terms of safety compared to an arrangement with two independent suction tunnels each provided with a water intake and where local obstruction of one of the two tunnels necessarily implies a loss of supply to the basin by the corresponding water intake.

According to an advantageous embodiment of a water intake installation according to the invention, the suction tunnel comprises at least one curved section having a radius of curvature of between 50 meters and 300 meters. Such an arrangement will generally allow excavation of the looped suction tunnel by a single TBM along a single path, for a total length such that the tunnel construction cost is less than the cost required to dig two independent suction tunnels.

In other preferred embodiments of a water intake installation according to the invention, one or more of the following arrangements are used:
said curved section forms a circular arc extending for at least a semicircle;
said at least one water intake is submerged at a depth in the body of water such that the water temperature at said depth remains below 21° C. for the entire year and preferably below 16° C.;
the installation comprises a second suction tunnel connected to at least two water intakes submerged in said body of water, said second suction tunnel forming a loop having two ends which communicate with the suction basin.
at least one of the two ends of the suction tunnel is extended by a service tunnel comprising a sloping portion which opens at ground level, said service tunnel having been excavated by a TBM which was used to excavate the suction tunnel.
said at least two submerged water intakes are located at an upper end of a substantially vertical suction shaft connected to the suction tunnel and are at least 100 meters apart from each other.
the suction basin is located in a bottom portion of a channel, said channel comprising an intake portion which communicates with said body of water, and the installation comprises at least one wall which creates a separation between said bottom portion and said intake portion of the channel such that the water of the suction basin does not mix with the water of said intake portion of the channel.
the suction basin is covered by a substantially watertight cover device, and calibrated openings between the suction basin and the environment outside the basin are created in or near said cover device so as to allow a limited flow of water from the suction basin to said outside environment when the basin is completely full due to unusually high water in said body of water.
the two ends of the loop formed by the suction tunnel are positioned in a same underground cavity which communicates with the suction basin via a single generally vertical passage.

The invention also relates to a nuclear power plant comprising at least one reactor unit and a water intake installation according to the invention, wherein the suction tunnel and each of said water intakes are sized such that that the supply of water to the suction basin by only one of either of the two ends of the suction tunnel, and by only one of said water intakes, is sufficient to supply water to all pumping stations of said installation during normal operation of said one reactor unit or all reactor units of the plant. In the case of a plant comprising at least two reactor units, said suction basin may advantageously be adapted to supply water to a plurality of pumping stations each assigned to a reactor unit.

The invention also relates to a nuclear power plant comprising at least two reactor units and a water intake installation according to the invention, wherein the water intake installation comprises at least a second suction tunnel forming a loop and having two ends which communicate with the suction basin.

The invention also relates to a method for creating a water intake installation according to the invention, implementing a step of excavation of the suction tunnel by a TBM along a predetermined path, wherein said excavation step successively comprises the following steps:
the TBM excavates a first tunnel section sloping downward from a ground-level starting area, until a first underground area is reached at a predetermined depth beneath a first area of the suction basin, said first underground area constituting a first end of the loop formed by the tunnel;
the TBM continues excavating the tunnel to form a second section oriented toward the body of water, and then to form a third circular arc section followed by a fourth section oriented toward the plant, said fourth section reaching a second underground area located at a predetermined depth beneath a second area of the suction basin, said second underground area constituting a second end of the loop formed by the tunnel;
   and wherein a first generally vertical passage connecting said first underground area to said first area of the suction basin is excavated, and a second generally vertical passage connecting said second underground area to said second area of the suction basin is excavated.

Said excavation step may comprise a third step during which the TBM excavates a fifth tunnel section comprising a portion sloping upward from said second underground area to a ground-level ending area through which the TBM emerges from the tunnel.

Other features and advantages of the invention will be apparent in the following description of some non-limiting exemplary embodiments, with reference to the figures in which:

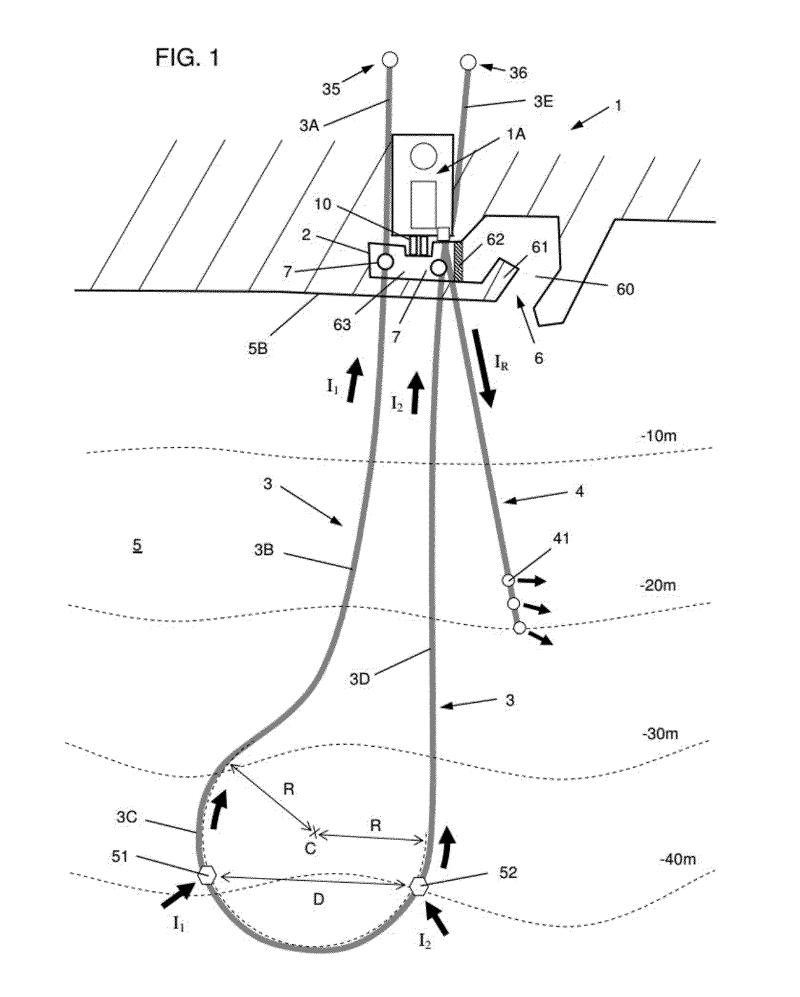

FIG. 1 schematically represents a top view of a nuclear power plant near the shore, the plant having been modified to implement a water intake installation according to a first embodiment of the invention, the flows of water circulating in the installation being represented for normal operation of the plant.

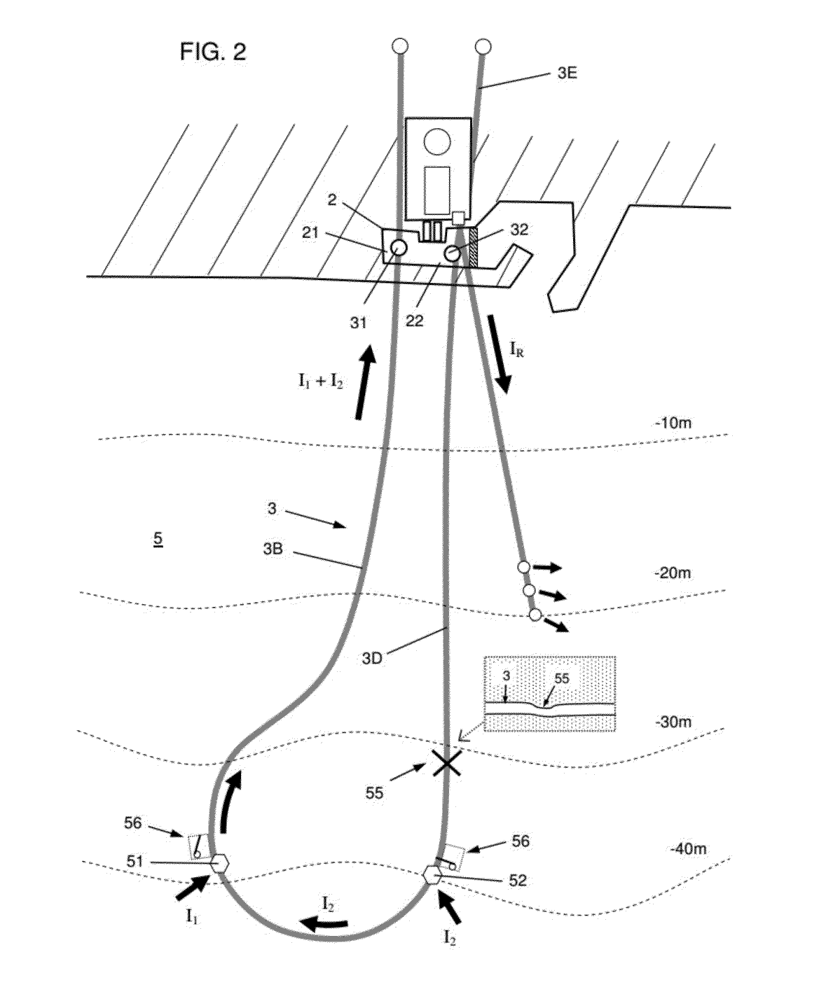

FIG. 2 schematically represents a top view of the nuclear plant of FIG. 1, the flows of water circulating in the installation being represented for a degraded operation of the suction tunnel following a collapse, this situation still allowing normal operation of the plant to continue.

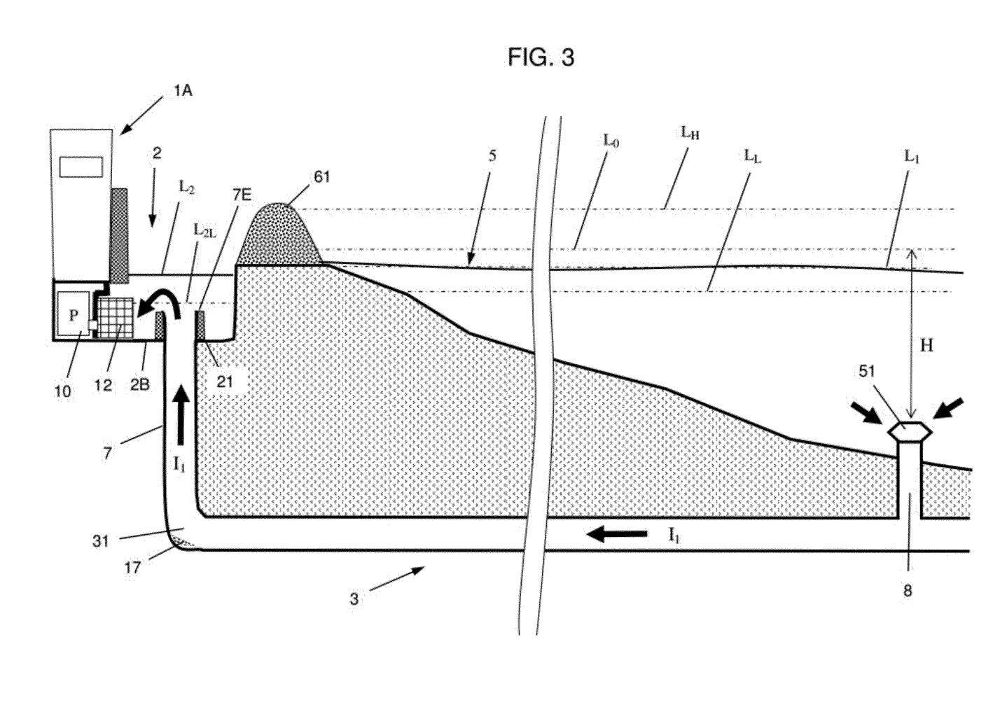

FIG. 3 schematically represents a partial side view of the water intake installation represented in FIG. 1, as well as the different tide levels to be taken into account in the design.

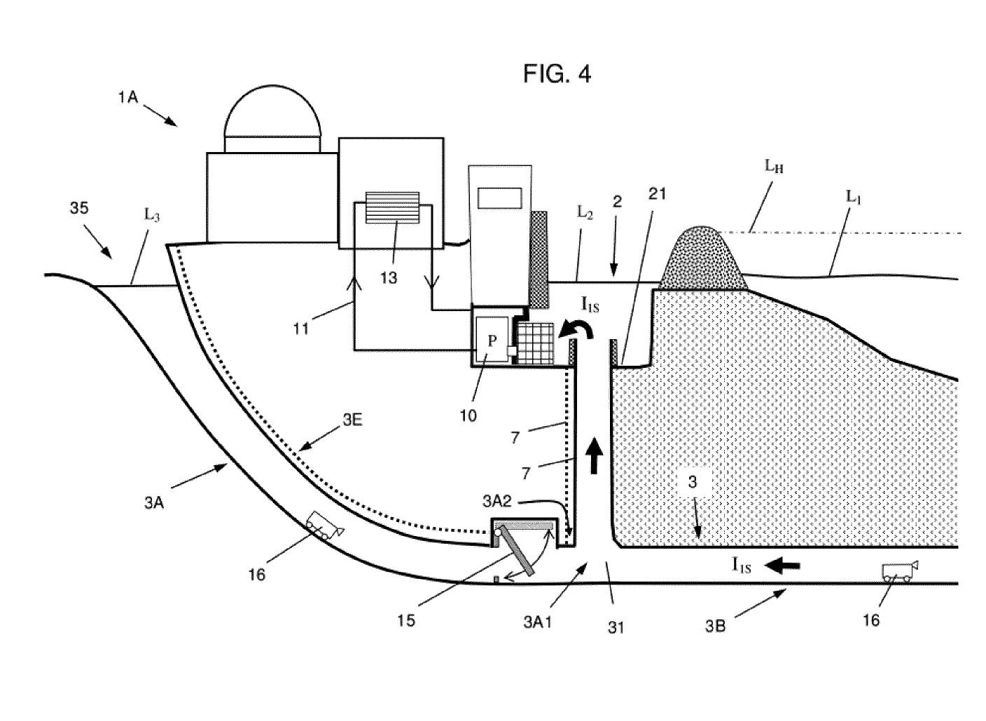

FIG. 4 schematically represents a partial side view of an improvement of the water intake installation represented in FIG. 3.

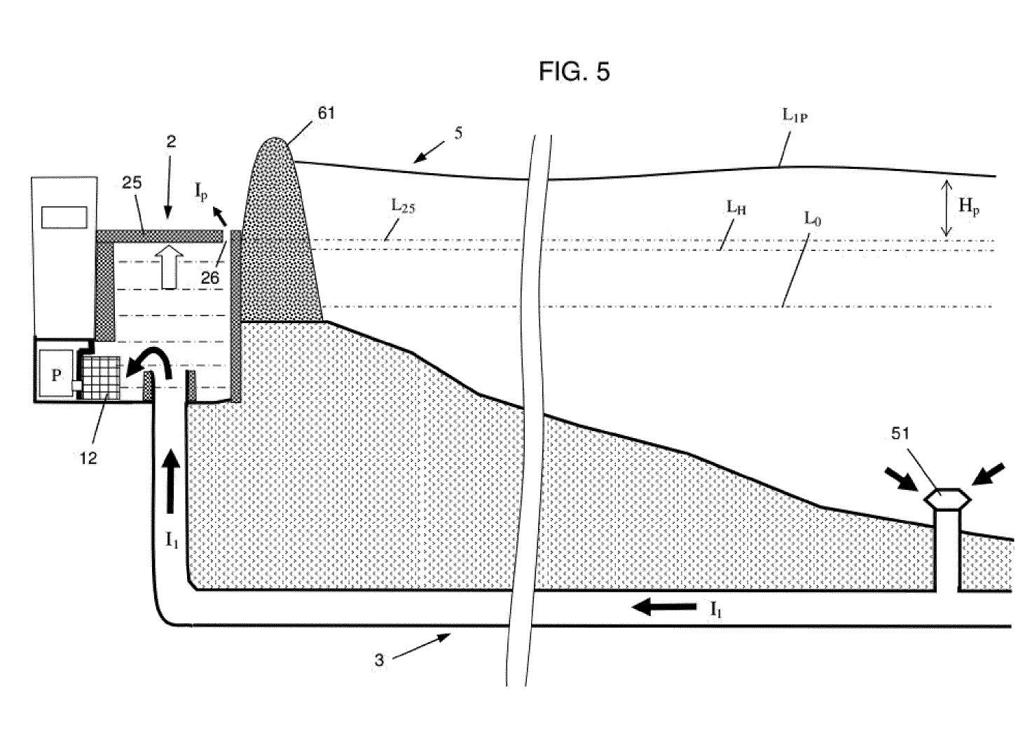

FIG. 5 schematically represents a partial side view of a water intake installation for a nuclear power plant that may be exposed to a tidal wave, with different water levels to be taken into account in the design.

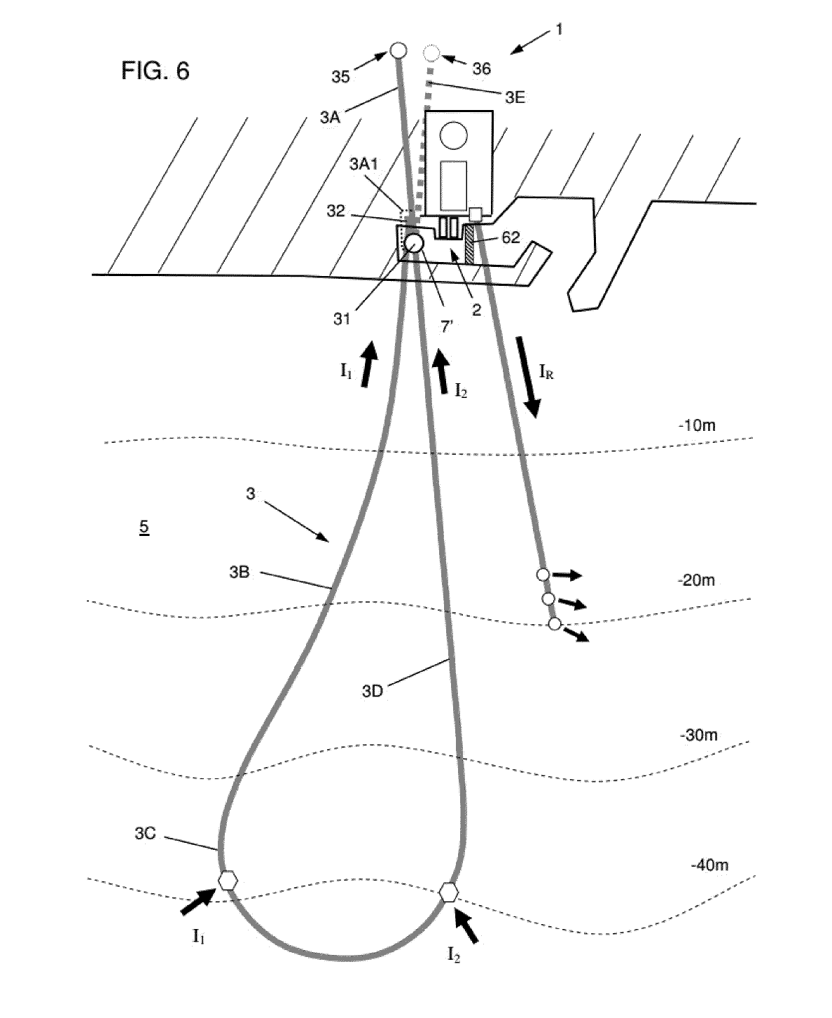

FIG. 6 schematically represents a top view of the nuclear plant of FIG. 1, modified to implement a water intake installation according to another embodiment of the invention.

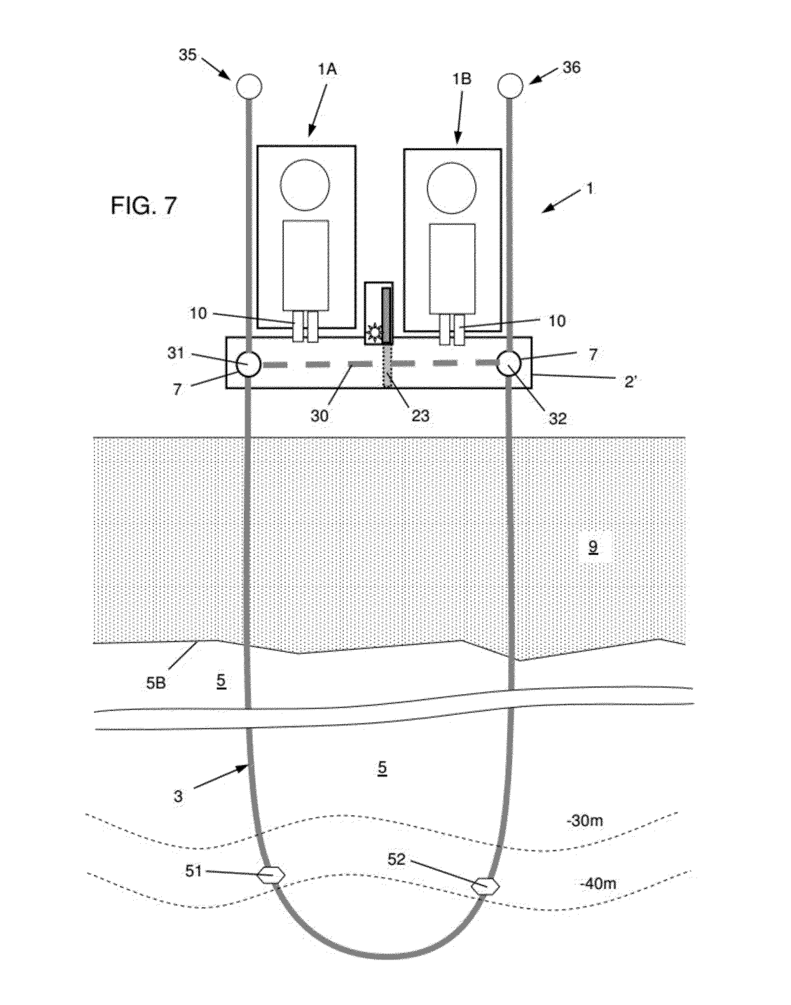

FIG. 7 schematically represents a top view of a nuclear power plant comprising two reactor units supplied with water by the same suction basin, and comprising a water intake installation according to the invention with a single suction tunnel.

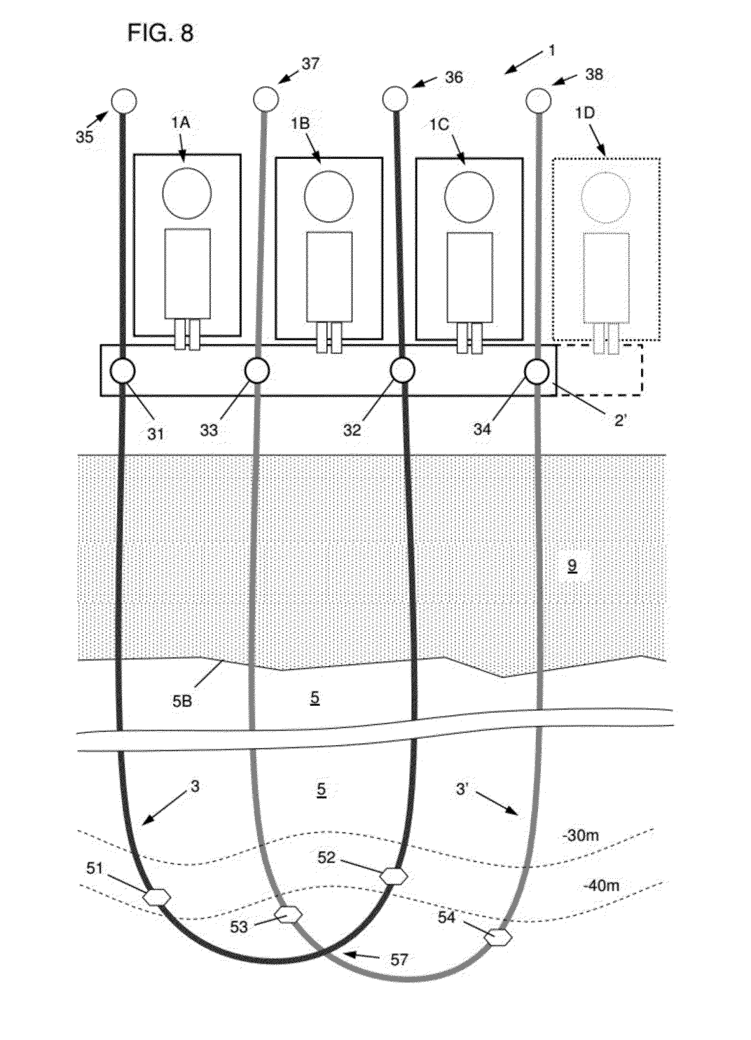

FIG. 8 schematically represents a top view of a nuclear power plant comprising at least three reactor units supplied with water by the same suction basin, and comprising a water intake installation according to the invention with two suction tunnels.

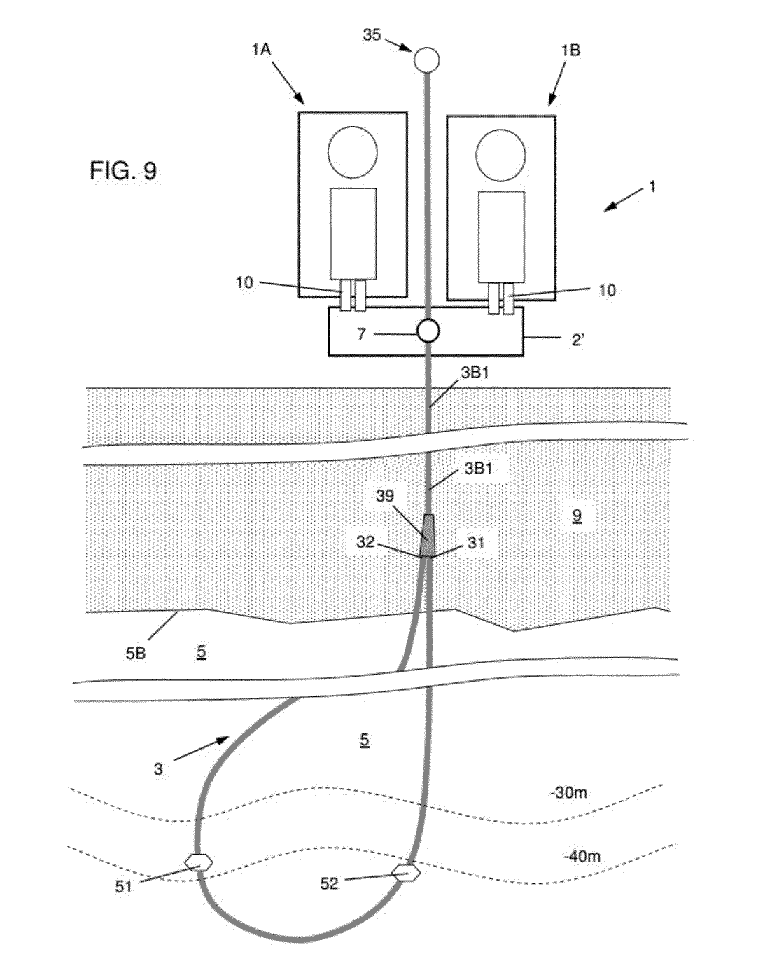

FIG. 9 schematically represents a top view of a nuclear power plant supplied with water by one suction basin, and comprising a water intake installation according to the invention with a suction tunnel in which the two ends of the portion forming a loop are at a distance from the suction basin.

FIG. 1, FIG. 2, and FIG. 3 represent the same water intake installation according to a first embodiment of the invention, and are discussed together in the following. The water intake installation is installed at the site of a nuclear power plant 1 by the seashore, and modifies an existing installation in order to significantly reduce the temperature of the water in a suction basin 2 from which a plant pumping station 10 supplies cold water to at least one heat exchanger-based cooling circuit of the plant.

The suction basin 2 is located in a bottom portion 63 of a channel 6 comprising an intake portion 60 in communication with the sea 5. The channel 6 is protected from the sea by a dike 61 between the channel and the shoreline 5B. Before said modification, the suction basin was in communication with the intake portion 60 and was therefore supplied with water by the channel. Water entering the pumping station 10 was therefore substantially the same temperature as the surface water at the shore.

The modified installation comprises a wall 62, for example in the form of a dam wall, which creates a separation between the bottom portion 63 and the intake portion 60 of the channel, so that water from the suction basin 2 does not or virtually does not mix with the water of the intake portion of the channel. Water is supplied to the suction basin 2 via an underground suction tunnel 3 communicating with the basin through two shafts each formed by a generally vertical passage 7 which opens to the bottom of the basin, as represented in FIG. 3.

The suction tunnel 3 is visible in FIGS. 1 and 2 for explanatory purposes, but it is understood that this tunnel is buried below the seabed and is therefore not visible from the sea. The tunnel 3 extends to a certain distance from the shoreline, passing below the bed to reach a depth below sea level (MSL in France) that is determined based on a maximum temperature that the water in the suction basin is not to exceed. Whatever the type of cold source for the heat exchanger-based cooling circuit, the efficiency η of a secondary circuit of the plant depends on the temperature Tf of the cold source, meaning the temperature of the water entering the heat exchangers, and is defined as follows:

η=(Tc−Tf)/Tc

Tc being the temperature of the heat source, meaning the temperature of the water exiting the heat exchangers. The efficiency η therefore increases with the decreasing temperature Tf of the cold source.

To improve the efficiency of a secondary circuit of an existing installation, or when planning a new nuclear power plant, the design of heat exchangers, as well as the requirements for normal operation as well as degraded operation of the installation, dictate the temperature that the cold source must not exceed.

Depending on the nature of the body of water and on the region where the plant is installed, this maximum temperature for the cold source implies that the water intakes communicating with the underground suction tunnel must be placed at a depth at least equal to a predetermined minimum depth. For example, for a nuclear power plant to be constructed at a site bordering the Mediterranean Sea, if the cooling systems are sized so that the maximum temperature of the cold source is set at 20° C., the minimum depth of the water intake is about 35 meters below sea level, which is in the thermocline layer. This means that during the period of the year when the sea is the warmest, generally during the months of August and September, one must go down to about 35 meters for the water temperature never to exceed 20° C.

A cooling system for a nuclear reactor is characterized by an optimum temperature of the cold source during operation, which is lower than the maximum temperature specified for the system. For example, when the maximum cold source temperature is set at 20° C., the optimum operating temperature can be about 15° C. Based on thermocline curves for the sea, meaning curves each representing a particular period of the year (for example a month) and showing the relationship between a given depth and the water temperature at that depth, one can determine that a depth of 70 meters must be reached for the water temperature never to exceed 15° C., which is still within the thermocline layer. At such depths, the water temperature varies very little during the year, and for example will not fall below 13° C. during the coldest months. It is clear that it is inadvisable in this example to draw water from depths greater than 70 meters in order to further improve efficiency, because the additional cost of the tunnel construction would be too great compared to the small improvement in efficiency.

The depth at which we obtain the best balance between the cost of constructing the water intake installation and the expected efficiency for the installation can be determined by knowing the estimates for the construction costs of the suction tunnel 3 at different depths, while also knowing the efficiency of the installation according to the temperature of the cold source, and using the thermocline curves for the sea.

In the case of a new nuclear power plant by the sea, this construction cost is compared to the cost of constructing a plant with a conventional cooling system in which the water of the suction basin is supplied by a channel. A new plant with a cooling system according to the invention will generally be more expensive overall because of the construction of the suction tunnel. However, savings will be made in the heat exchangers and circulation pumps in particular, including the associated civil works, which can be of smaller dimensions due to the decrease in the maximum temperature of the cold source. In addition, pulling water from greater depths eliminates various contaminants such as chemicals, plants (algae), or floating objects, which simplifies the filtration systems and reduces their construction and maintenance costs.

The additional construction costs for a new plant with a cooling system according to the invention are therefore not necessarily very high. In addition, improving plant efficiency during some or all of the year, depending on the region, helps generate greater operating margins and thus improves the cost-effectiveness of the installation, especially in regions where the surface temperature of the sea often exceeds 25° C. The added construction cost can therefore be offset by the improved efficiency of the installation relatively quickly in comparison to the expected service life of the plant, which over the long or longer term will result in a decreased total cost including construction and operation.

In the embodiment represented in FIG. 1, the suction tunnel 3 lies under the seabed at depths of about 40 meters below sea level, and is connected to two water intakes 51 and 52 spaced apart from each other by a distance D of at least 100 meters. A distance of at least 100 meters minimizes the risk of simultaneous failure of the two water intakes. For example, it is extremely unlikely that a boat sinking near the water intakes would damage both intakes 51 and 52, because of the distance separating them. Each water intake sits a few meters above the seabed to avoid sucking sediment into the suction tunnel 3, and is located at an upper end of a substantially vertical suction shaft 8 connected to the suction tunnel as represented in FIG. 3. The depth H of a water intake 51 or 52 below sea level L₀ may be determined as described above in order to obtain the best balance between construction cost of the water intake installation and the expected efficiency of the installation.

The suction tunnel 3 forms a loop having two ends 31 and 32 which each communicate with the suction basin 2, as represented in FIG. 2 and FIG. 3. Each end 31 and 32 of the tunnel loop is located vertically below a respective corresponding area 21 or 22 of the suction basin, and communicates with the suction basin via a generally vertical passage 7. As shown in FIG. 3, an end 31 or 32 of the tunnel loop may form an elbow with the vertical passage 7, which helps trap at the bottom of the elbow any sediment 17 which may have been sucked into the tunnel. To avoid unnecessary head loss in the circuit before the suction basin is reached, the inside diameter of the vertical passage 7 is preferably less than the inside diameter of the tunnel 3. The latter is, for example, about 5 meters.

The loop formed by the suction tunnel 3 lies in a horizontal plane, thereby facilitating the work of the TBM along the loop during construction, by eliminating the need to manage the movement and evacuation of earth on sloping ground. However, it is conceivable to have sloping sections in the loop, for example to adapt to a particular subsoil geology. A very slight upward slope towards the suction shaft 8 would allow emptying water from the tunnel if needed, for example for an exceptional repair during plant shutdown, by first closing the water intakes 51 and 52 and then pumping water out the ends 31 and 32 of the loop as these would constitute the lowest points of the tunnel. However, as explained below, the tunnel design normally does not require draining the water in order to perform maintenance when there is damage in the tunnel. Conversely, a downward slope towards the suction shafts 8, for example with an incline of between 10° and 20°, would reduce the required height of each vertical passage 7 and would somewhat shorten the total length of the circuit. With the current state of TBM excavation techniques, excavating a tunnel loop in a substantially horizontal plane seems the simplest solution.

The suction tunnel 3 has a curved section 3C having a radius of curvature R of between 50 meters and 300 meters. Advantageously, this curved section 3C forms an arc of a circle with center C and radius R, extending for more than a semicircle, in order to minimize the total length of the tunnel considering that the ends 31 and 32 of the loop are relatively close or may even coincide (see FIG. 6). A tunnel having at least one curved section can be constructed using current TBM excavation techniques with reinforcing segments for the walls excavated by the TBM. The reinforcing segments are individually resistant and preformed concrete blocks. To create a reinforcement module extending 360°, meaning that is ring-shaped, one can use four identical segments and an additional segment forming a keystone, these segments interconnected by elastomer seals. The length of a reinforcement module is for example about one to two meters for an inside diameter of five meters.

The successive reinforcement modules along the tunnel are also interconnected by elastomer seals, and are angularly offset pairwise about the axis of the module such that two consecutive keystones are not aligned. The relative flexibility of the connection by elastomer seals also creates a slight misalignment between the axes of two consecutive modules, which allows constructing at least one tunnel section having a certain curvature. Current techniques for tunnels intended for vehicular traffic allow a radius of curvature of about 150 meters without compromising the mechanical strength of the tunnel wall provided by the assembled segments. For a suction tunnel as described herein, a smaller radius of curvature is possible, particularly as the mechanical stresses are slightly lower once the tunnel is filled with water.

The excavation of the suction tunnel 3 can be performed by a TBM which successively executes the following steps. In a first step, the TBM is placed in a ground-level starting area 35 located at a distance from the suction basin 2 and from the reactor unit 1A, the distance of the ground-level starting area relative to the suction basin being a function of the depth at which the TBM must pass beneath the basin. The TBM digs a first section 3A of the tunnel which slopes downward toward the sea, until it reaches a first underground area 3A1 at a predetermined depth under a first area 21 of the suction basin, as shown in FIG. 2 and FIG. 4. The first underground area 3A1 constitutes the first end 31 of the loop formed by the tunnel. In a second step of forming the loop of the tunnel, the TBM continues digging the tunnel to form a second section 3B substantially oriented towards the location where a first submerged water intake 51 will be located, and then to form a third circular arc section 3C passing under the intended location of the first water intake 51 and under the intended location of a second water intake 52, followed by a fourth section 3D oriented towards the plant 1. The fourth section 3D is intended to reach a second underground area 3A2 located a predetermined depth beneath a second area 22 of the suction basin. The second underground area 3A2 constitutes the second end 32 of the loop formed by the tunnel, and is located at substantially the same depth as the first underground area 3A1.

During a third excavation step, the TBM digs a fifth section 3E of the tunnel which slopes upward from the second underground area 3A2 to a ground-level ending area 36 through which the TBM can exit. Note that this third step is not essential to creation of the tunnel. It may be arranged for example that the TBM abandons its cutter head after digging the second underground area 3A2, and then reverses through the tunnel to exit at the ground-level starting area 35. The excavation of a first section 3A or of a fifth section 3E of the tunnel must be done so that the terrain is not weakened, especially underneath the nuclear facility. It is therefore highly preferable that these tunnel sections pass under areas remote from the sensitive systems of a reactor unit.

To connect the suction basin 2 to the first and second ends 31 and 32 of the loop formed by the tunnel, a first generally vertical passage 7 is dug that connects the first underground area 3A1 to the first area 21 of the suction basin, and similarly a second generally vertical passage 7 is dug that connects the second underground area 3A2 to the second area 22 of the suction basin. The walls of these passages 7 are covered with concrete, or may be defined by metal tubes. Note that the first and second passages 7 can be dug before, during, or after excavation of the tunnel. At least one of the respective first and fifth sections 3A and 3E of the tunnel may be resealed after excavation, as is the case in the embodiment shown in FIG. 3. It is also possible to retain at least one of the first and fifth sections 3A and 3E and cover the walls with concrete in order to create a service tunnel providing easy access for tunnel inspection and maintenance, as is the case in the embodiment shown in FIG. 4 and discussed below in the description.

Alternatively, the suction tunnel 3 may be excavated after excavating a shaft for the generally vertical passage 7, and placement of the TBM can be done by lowering its successive elements down to the bottom of the shaft, in particular the drilling part followed by the cars. It is therefore not necessary to dig a first downward sloping section of the tunnel such as said section 3A.

In what follows, it is assumed that the body of water 5 is a sea subjected to tides. It is understood that the embodiment described is also suitable for a body of water having no substantial change in level. Each wall of a passage 7 opens into the suction basin 2 at a level which is substantially below the level L_{L} of the lowest tide during the largest tidal coefficients, see FIG. 3. Indeed, the supply to the suction basin of water drawn from the sea is effected by equilibrium of the levels due to atmospheric pressure. Given the head losses in the suction shaft 8 and in the tunnel, the level L₂ of the water in the suction basin is located at a height which may be several centimeters or even tens of centimeters below the level L₁ of the sea measured above the water intakes 51 and 52, the level L₁ in question being the average between the peaks and troughs of the swell waves. When the water level L₁ reaches the level L_{L} of the lowest tide, the level L₂ of the water in the suction basin reaches a level L_{2L} which must be at a certain height above the mouth 7E of a passage 7, to avoid progressive emptying of the suction basin by the normal operation of the pumps in the pumping station 10. The height of the suction basin is such that when the level L₁ of the sea reaches the level L_{H} of the highest tide during the largest tidal coefficients, the water does not overflow the suction basin.

Advantageously, the mouth 7E of a passage 7 is located at a predetermined height above the bottom 2B of the suction basin so that in the event of an exceptional drop of the body of water 5 below level L_{L}, as can occur for example at the ocean's edge in areas prone to tsunamis, a reserve of water remains available in the suction basin. This provides the time to stop power generation by the reactor unit and to switch from the normally operating pumps in the pumping station 10 to backup pumps, with no interruption in the supply of water to the pumps.

During normal operation of the reactor unit 1A of the nuclear power plant 1, and with a fully operational suction tunnel 3 as shown in FIG. 1 and FIG. 3, the water intakes 51 and 52 allow the tunnel to pull water in respective streams I₁ and I₂ flowing at a speed that is a function of the flow rate of the pumping station 10. If during normal operation the reactor unit 1A at full power requires about 70 m3 per second of water to cool it for example, the flow rate of each stream I₁ or I₂ is about 35 m3 per second of water. Moreover, in a known manner the pumping station comprises pumps to circulate the water exiting the heat exchanger-based cooling circuit in an outflow tunnel 4 which leads to underwater discharge mouths 41 located at a distance from the water intakes. The flow rate of the stream I_{R} of water discharged by the outflow tunnel 4 is normally equal to the sum of the flow rates of streams I₁ and I₂.

In the case of localized damage to the tunnel 3, for example in an area 55 of the tunnel that has collapsed as schematically shown in FIG. 2, the reinforcing segments of the tunnel walls as mentioned above may be displaced in a direction transverse to the tunnel. This can result in a localized narrowing of the inside cross-section of the tunnel. Studies conducted by the applicant allow us to assume that in the case of the most serious collapses for a tunnel having an inside diameter of about 5 meters, the inside cross-section of the tunnel within the damaged area will remain sufficient to allow a flow rate for example of at least 5 m3 per second of water and greater than the backup flow rate required by the backup pumps in the pumping station 10. A backup flow rate of about 4 m3 per second of water is usually enough to cover the water supply requirements of a pumping station of a reactor unit where the generation of electricity has been stopped.

In the case represented in FIG. 2, only one section of the tunnel has a collapsed area 55. Even assuming that the inside cross-section of the tunnel is greatly reduced within the collapsed area 55, it is possible to continue normal operation of the reactor unit 1A. In the example represented, the flow rate of the pumping station 10 during normal operation is about 70 m3 per second of water, which means about 35 m3 per second of water per arm of the tunnel. Even assuming that the collapsed area 55 only allows about 5 m3 per second of water to flow in the arm of the tunnel between the second water intake 52 and the second end 32, the portion of the tunnel loop from the second water intake 52 to the first end 31 of the loop is undamaged and allows supplying water to the suction basin 2 at the required flow of about 70 m3 per second of water.

As the two water intakes 51 and 52 are undamaged, the rate of supply to the suction basin 2 remains distributed approximately equally at each water intake, such that each stream I₁ or I₂ is about 35 m3 per second of water for a suction basin flow rate of about 70 m3 per second of water. In addition, assuming that one of the two water intakes 51 and 52 has been damaged, the water intake installation is designed so that the other water intake 51 or 52 can alone provide the flow rate required for continuing normal operation of the reactor unit. The sizing of each water intake 51 or 52 and of the associated suction shaft 8 is determined accordingly. Thus, despite the suction tunnel 3 operating in a mode that can be described as degraded, the reactor unit 1A can continue to operate normally.

Such a design of the water intake installation can also be applied to a configuration of the plant 1 where cooling circuits for multiple reactor units are supplied with water from the same suction basin. An example of such a configuration is represented in FIG. 7 and is discussed further below. It is understood that in general, the suction tunnel 3 and each of the water intakes 51 and 52 are sized so that the supply of water to the suction basin by only one of either of the two ends 31 and 32 of the suction tunnel and by only one of the water intakes is sufficient to supply water to all pumping stations 10 of the water intake installation during normal operation of all reactor units of the plant.

It is possible to aim for maximum safety while conducting certain maintenance and repair operations in the tunnel without interrupting the normal operation of the reactor unit or units supplied with water by the tunnel. For example, to repair the collapsed area 55 of the tunnel without shutting down unit 1A, and in order to restore an inside cross-section of the tunnel that is equivalent to the original in that area 55, it is possible during tunnel construction to equip some tunnel sections with gate valves 56 adjacent to the suction shafts 8 associated with the water intakes 51 and 52. Such a gate valve 56 may be a hinged door arranged in a recess along a side of the tunnel, and operable from outside the tunnel by a diver or underwater robot after the safety mechanisms are deactivated. A maintenance shaft for accessing the gate valve can be provided that adjoins a suction shaft 8.

In the example of FIG. 2, the gate valve 56 adjacent to the suction shaft of the water intake 52 is closed after it is detected by any suitable means that the water flow has decreased substantially in the passage 7 associated with the end 32 of the loop. Closing this gate valve 56 eliminates the risk that a robot, diver, or equipment entering that tunnel section 3D from the service tunnel 3E in order to inspect and repair this section, will reach the suction shaft of the water intake 52 and be moved into section 3B of the tunnel by the pull of the water corresponding to stream I₂. Once in the arm of the tunnel between the first water intake 51 and the first end 31, the flow of the suction current is doubled, and a diver in particular could be pulled into the filtration system 12 of the suction basin, see FIG. 3. Such a gate valve 56 is not necessarily fluidtight, and may include a grille sized to retain objects or people who have traveled too far beyond the collapsed area 55. However, a relatively fluidtight gate valve 56 allows greatly limiting the flow of water between the second water intake 52 and the second end 32 of the loop, which can be advantageous for conducting repairs within the collapsed area 55 without the interference of water currents.

As represented in FIG. 4, the first and fifth sections 3A and 3E excavated by the TBM have been retained in order to provide first and second service tunnels for ground-level access to the first and second ends 31 and 32 respectively of the tunnel loop. In FIG. 4, the fifth section 3E is located behind the first section 3A and is partially indicated in phantom lines. The dimensions of the two service tunnels may be identical. It may be arranged so that the tunnel walls are inspected by at least one autonomous underwater vehicle 16 moving on a guide rail or track provided for this purpose along the tunnel, the inspection vehicle being equipped with spotlights and image capturing devices for example and possibly being able to communicate with a control station. A complete inspection of the tunnel can be performed by introducing the inspection vehicle 16 by the first service tunnel 3A and removing the vehicle by the second service tunnel 3B.

This tunnel inspection operation can be arranged to be achievable during normal suction in the suction basin 2 from the normally operating pumps of the pumping station 10, but the inspection vehicle 16 must then go up the first arm of the tunnel against a suction current for example of about 35 m3 per second of water, which corresponds to a current velocity of about 1.8 meters per second for an effective diameter of the tunnel of about 5 meters. The power and autonomy of an inspection vehicle 16 must therefore be adapted accordingly. To the extent possible, it is preferable to carry out thorough inspections of the tunnel during a phase where power generation of a reactor unit is shut down and water is only being pumped by the backup pumps of the pumping station 10 associated with the suction basin. The water suction current I₁ₛ is then reduced, for example to about 2 m3 per second of water for each arm of the tunnel, which means a current velocity of about 0.1 meters per second which is very low. Under these conditions of very low water current pull, divers can work safely with no risk of being carried away by the current.

The first and second service tunnels 3A and 3E connect with the first and second underground areas 3A1 and 3A2 respectively. At each ground-level starting area or ending area 35 or 36, the water in the service tunnel has a level L₃ which substantially corresponds to the level L₂ in the suction basin. A ground-level area 35 or 36 may be provided that is raised so that a high level L₃ does not flood the plant. Conversely, if at the location of the ground-level area 35 or 36, the service tunnel end opens at an altitude much lower than the level L_{H} of the highest tide during the largest tidal coefficients, as is the case in the embodiment represented in FIG. 4, the location may be flooded during high tides. It is possible to provide a gate valve 15 in the service tunnel, for example a hinged door, arranged in a recess along a side of the tunnel and operable for example from inside the tunnel by a diver. The gate valve 15 can function as a check mechanism, which implies that the level L₃ of water in the service tunnel will not substantially exceed the level of low tide during the period concerned. The watertightness of the gate valve 15 does not necessarily have to be very good. Forced opening of a gate valve 15 to allow passage of an inspection vehicle 16 or divers will be performed at a tide sufficiently low to avoid possible flooding of area 35 or 36.

As represented in FIG. 5, a water intake installation according to the invention can be adapted for a nuclear power plant located beside a body of water likely to experience an unusual rise in water. An unusual rise in water is understood to mean a tidal wave as caused for example by a tsunami, or flooding of a river. A water intake installation such as the one represented in FIG. 1 requires relatively few arrangements to withstand an unusual rise in water. The dike 61 must be of sufficient height to prevent being flooded by the highest waves of estimated height L_{1P}, see FIG. 5. Moreover, the dike 61 must protect the plant completely, and therefore there is no longer any question of being open to the sea such as via a channel.

To avoid uncontrolled overflow of the suction basin 2, the basin is covered by a device forming an essentially watertight cover 25. Calibrated openings 26 can be made in the cover 25 or nearby, for example in a side wall of the basin, between the basin and its outside environment. In this manner, if the basin is completely filled due to an unusual rise in the water, the calibrated openings 26 allow a limited flow of water Iₚ from the suction basin to the outside environment, possibly channeling this flow to an intermediate discharge area before its discharge into the sea.

The water pressure in the suction basin 2 at the cover 25 is in particular a function of the height Hₚ of the sea vertically above the water intakes 51 and 52, relative to a reference level L₂₅ corresponding to the altitude of the cover 25. Depending on the water flow Iₚ through the calibrated openings 26, the suction basin 2 will be depressurized to a greater or lesser extent. It is possible to dispense with the openings 26, but the structures of the basin 2, the cover 25, and the filtration system 12, would have to withstand the added pressure. A height Hₚ of about 10 meters would involve a pressure of close to 1 bar being applied to the underside of the cover 25 such as at the location indicated by the arrow, offset by the head losses in the tunnel. Moreover, if the rising water is due to a tsunami, and no earthquake preceding the tsunami affected the plant, it is possible not to shut down the reactor unit and therefore not to shut down the normally operating pumps of the pumping station 10 during the rise of the water.

It is possible to arrange the water intake installation described above with reference to FIG. 5, so that it implements the embodiment described above with reference to FIG. 4 in relation to having at least one service tunnel for accessing the tunnel loop from ground level. In this case, a gate valve such as gate valve 15, possibly positioned at the ground-level starting area 35, will prevent flooding of the plant by the service tunnel when the water rises. In addition, to prevent the rising water from flooding the plant through an outflow shaft feeding an outflow tunnel such as tunnel 4 in FIG. 1, the outflow shaft or shafts of the pumping station may each be provided with a covering device similar to the one serving as cover 25 and possibly comprising calibrated openings for pressure relief.

In FIG. 6, the represented water intake installation differs from the one corresponding to FIG. 1 essentially in that the first and second ends 31 and 32 of the tunnel loop are more or less in coincidence in a same underground cavity 3A1 located beneath the suction basin 2. The first and second ends 31 and 32 are in communication with the suction basin via a single generally vertical passage 7′ which connects the underground cavity 3A1 to the suction basin. When excavating the tunnel, it may be arranged so that the TBM is withdrawn through an exit section 3E to a ground-level starting area 36 where the TBM can be removed, as described with reference to FIG. 1, or the TBM is redirected into the underground cavity 3A1 where it can be withdrawn through the starting section 3A to the ground-level starting area 35.

An advantage of such an embodiment is that it requires only one suction passage 7′. However, when repairs need to be carried out within the tunnel, such as repairing a collapsed area of the tunnel 55 as described with reference to FIG. 1, it may be necessary to switch from the normally operating pumps of the pumping station to the backup pumps in order to gain access to the damaged arm of the tunnel 3 through a service tunnel 3A or 3E without the danger of being sucked into the suction passage 7′.

In FIG. 7, the represented nuclear power plant differs from the one corresponding to FIG. 1 essentially in that it comprises two reactor units 1A and 1B provided with water by the same suction basin 2′. It is understood that the invention is not limited to a suction basin which forms a continuous volume. “Same suction basin” is also understood to mean a set of basins apart from each other and connected to each other for example by channels or pipes possibly fitted with valves, so that the water level in all the basins is the same or the difference between the water levels of the basins does not exceed a predetermined height. In the illustrated embodiment, the suction basin 2′ supplies water to two pumping stations 10 each assigned to a reactor unit of the plant. The water intake installation is similar to the one described with reference to FIG. 1. Note that the nuclear power plant is separated from the water's edge 5B by a strip of land 9, for example corresponding to a coastal area not authorized for construction. For simplicity, the system for discharging the water heated by the heat exchangers is not represented.

Optionally, a gate valve 23 may be provided for separating the suction basin 2′ into two parts, and possibly a connecting tunnel 30 as indicated with dotted lines beneath the basin and connecting the first and second ends 31 and 32 of the suction tunnel 3. The gate valve 23 may be a raising gate with a raising device arranged above a central area of the basin, and may be designed to remain open during normal operation of the two reactor units 1A and 1B. It may be decided to close it if one unit is shut down, for example to allow maintenance on the pumping station for that unit's part of the suction basin while preventing water from being pulled from that part of the basin toward the pumping station of the working unit. In this configuration, the connecting tunnel 30 is not essential but does provide additional security in the water supply from the active part of the suction basin 2′, namely through the first end 31 of the tunnel, without needing to reopen the gate valve 23. This satisfies the single-failure criterion even during maintenance on a unit that is shut down while the other of the two units remains active.

Alternatively, it is possible to divide the suction basin 2′ permanently into two parts, for example by means of a permanent wall instead of the above gate valve 23, to facilitate maintenance activities in the suction basin. In such an embodiment, it is necessary to ensure a fluid connection such as the one provided by the connecting tunnel 30, to satisfy the single-failure criterion concerning the supply of water to each pumping station. As previously mentioned, it is also possible to create the suction basin 2′ as two separate parts apart from each other, as long as these parts are connected to allow the flow of fluid. The fluid connection may possibly be fitted with at least one gate valve that is generally closed and controlled for example so that it opens automatically in response to an abnormally low water level in either of the two parts of the suction basin.

In FIG. 8, the represented nuclear power plant differs from the one in FIG. 7 essentially in that it comprises at least one additional reactor unit 1C supplied with water by the same suction basin 2′, and in that the water intake installation comprises a second suction tunnel 3′ forming a loop. The second tunnel 3′ may be identical in structure to the first tunnel 3, and similarly has two ends 33 and 34 which each communicate with the suction basin 2′ by a generally vertical passage. Similarly to the first tunnel 3, the second tunnel 3′ is associated with two water intakes 53 and 54, and may also comprise at least one maintenance section sloping from a ground-level starting area 37 or from a ground-level ending area 38.

In the configuration shown, the first and second suction tunnels 3 and 3′ are staggered in depth, for example by about ten meters relative to each other, at least within an area 57 where the paths of the tunnels intersect when viewed from above. For example, the TBM excavating the second tunnel 3′ passes underneath the first tunnel 3 in the intersection area 57. The intersection area 57 is an area of relative weakness to any earthquakes that could occur in this area, since both tunnels 3 and 3′ could be damaged. However, if the tunnels are damaged only in this intersection area 57, water continues to be supplied to the suction basin 2′ by the four water intakes 51, 52, 53 and 54. Such a configuration having an area where the two tunnels intersect could be acceptable in terms of safety, particularly in areas of low seismic risk. It is understood that other configurations of the paths of the tunnels are possible, in particular with two tunnels arranged in the same plane without intersecting, which is preferable in areas where there is a risk of earthquakes. For example, it is possible to have two tunnels each having the same shape as that of FIG. 1 and symmetrical relative to each other. A configuration could also be provided for each tunnel where the first and second ends 31 and 32 of the tunnel loop are practically in coincidence, as in the embodiment with reference to FIG. 6 or in the embodiment with reference to FIG. 9 discussed below.

Despite the generally higher cost of construction, a configuration with two suction tunnels for a suction basin 2′ supplying water to at least three reactor units may be preferable in some cases over a configuration with a single suction tunnel 3 supplying the same number of reactor units. Indeed, doubling the water intakes and tunnel arms provides an even more secure supply of water to the basin, which may be preferable particularly in areas where there are geological hazards and for example seismic hazards that could cause a collapse in a tunnel. In addition, each of the two suction tunnels will have an effective diameter that is less than the effective diameter required for a single suction tunnel, which may be too large for excavation by existing TBMs. In particular, with a fourth reactor unit 1D, the effective diameter required for a single suction tunnel would be for example about 10 meters to enable a flow rate of 280 m3 per second of water in one arm of the tunnel in the event of collapse in the other arm of the tunnel, this being the flow rate required to cool four simultaneously operating reactor units.

In FIG. 9, the represented nuclear power plant differs from the one corresponding to FIG. 6 essentially in that the first and second ends 31 and 32 of the tunnel loop are joined in an underground connection area 39 that is at a distance from the underground area where the tunnel connects to a passage 7 beneath the suction basin. Thus, the tunnel loop is connected to the passage 7 by a single arm 3B1 of the tunnel. In the configuration shown, the nuclear power plant is separated from the edge of the water 5B by a strip of land 9 for example at least 500 m wide, and the tunnel arm 3B1 extends for at least 500 meters as well. Compared to a tunnel shape having the two ends 31 and 32 of the loop located beneath the suction basin, the tunnel length is shortened by a distance that is about the length of the arm 3B1, which can significantly decrease tunnel construction costs. The configuration represented may be particularly preferred in areas of geological stability where there is a very low risk of tunnel collapse, and even more particularly in an embodiment in which two similar tunnels supply water to the same suction basin, as the presence of the two tunnels completely satisfies the single-failure criterion.

1. A water intake installation for at least one heat exchanger-based cooling circuit of one or more reactor units of a nuclear power plant, comprising:
a suction basin supplied with water and from which at least one pumping station of the plant draws water in order to circulate it within said cooling circuit; and
a suction tunnel communicating with the suction basin to supply it with water, connected to at least two water intakes submerged in a body of water such as a sea, lake, or river;
wherein at least a portion of said suction tunnel forms a loop having two ends which communicate with the suction basin.

2. The water intake installation according to claim 1, wherein said suction tunnel comprises a curved section having a radius of curvature of between 50 meters and 300 meters.

3. The water intake installation according to claim 2, wherein said curved section forms a circular arc extending for at least a semicircle.

4. The water intake installation according to claim 1, wherein said at least one water intake is submerged at a depth in the body of water such that the water temperature at said depth remains below 21° C. for the entire year and preferably below 16° C.

5. The water intake installation according to claim 1, comprising a second suction tunnel connected to at least two water intakes submerged in said body of water, said second suction tunnel forming a loop having two ends which communicate with the suction basin.

6. The water intake installation according to claim 1, wherein at least one of the two ends of the suction tunnel is extended by a service tunnel comprising a sloping portion which opens at ground level, said service tunnel having been excavated by a tunnel boring machine which was used to excavate the suction tunnel.

7. The water intake installation according to claim 1, wherein said at least two submerged water intakes are located at an upper end of a substantially vertical suction shaft connected to the suction tunnel and are at least 100 meters apart from each other.

8. The water intake installation according to claim 1, wherein the suction basin is located in a bottom portion of a channel, said channel comprising an intake portion which communicates with said body of water, and the installation comprises at least one wall which creates a separation between said bottom portion and said intake portion of the channel such that the water of the suction basin does not mix with the water of said intake portion of the channel.

9. The water intake installation according to claim 1, wherein the suction basin is covered by a substantially watertight cover device, and calibrated openings between the suction basin and the environment outside the basin are created in or near said cover device so as to allow a limited flow of water from the suction basin to said outside environment when the basin is completely full due to unusually high water in said body of water.

10. The water intake installation according to claim 1, wherein the two ends of the loop formed by the suction tunnel are positioned in a same underground cavity which communicates with the suction basin via a single generally vertical passage.

11. A nuclear power plant comprising at least one reactor unit and the water intake installation according to claim 1, wherein the suction tunnel and each of said water intakes are sized such that the supply of water to the suction basin by only one of either of the two ends of the suction tunnel, and by only one of said water intakes, is sufficient to supply water to all pumping stations of said installation during normal operation of said one reactor unit or all reactor units of the plant.

12. The nuclear power plant according to claim 11, comprising at least two reactor units, wherein said suction basin supplies water to a plurality of pumping stations each assigned to a reactor unit.

13. The nuclear power plant comprising at least two reactor units and the water intake installation according to claim 1, wherein the water intake installation comprises at least a second suction tunnel forming a loop and having two ends which communicate with the suction basin.

14. A method for creating the water intake installation according to claim 1, implementing a step of excavation of the suction tunnel by a tunnel boring machine along a predetermined path, wherein said excavation step successively comprises the following two steps:
the tunnel boring machine excavates a first tunnel section sloping downward from a ground-level starting area, until a first underground area is reached at a predetermined depth beneath a first area of the suction basin, said first underground area constituting a first end of the loop formed by the tunnel;
the tunnel boring machine continues excavating the tunnel to form a second section oriented toward the body of water, and then to form a third circular arc section followed by a fourth section oriented towards the plant, said fourth section reaching a second underground area located at a predetermined depth beneath a second area of the suction basin, said second underground area constituting a second end of the loop formed by the tunnel;
and wherein a first generally vertical passage connecting said first underground area to said first area of the suction basin is excavated, and a second generally vertical passage connecting said second underground area to said second area of the suction basin is excavated.

15. The method according to claim 14, wherein said excavation step comprises a third step during which the tunnel boring machine excavates a fifth section of the tunnel comprising a portion sloping upward from said second underground area to a ground-level ending area through which the tunnel boring machine emerges from the tunnel.
